(19) United States
(12) Patent Application Publication
(10) Pub. No.: US 2013/0264524 A1
(43) Pub. Date: Oct. 10, 2013

(54) ELECTRODE AND FABRICATION METHOD THEREOF

(71) Applicants: Kang-Yu LIU, Taoyuan Hsien (TW); Chun-Wei Peng, Taoyuan Hsien (TW)

(72) Inventors: Kang-Yu LIU, Taoyuan Hsien (TW); Chun-Wei Peng, Taoyuan Hsien (TW)

(21) Appl. No.: 13/440,444

(22) Filed: Apr. 5, 2012

(51) Int. Cl. H01B 1/24; C01B 31/00; H01B 1/04; B82Y 30/00; B82Y 40/00

(52) U.S. Cl. 252/503; 423/448; 252/511; 252/502; 977/842; 977/932; 977/742; 977/779

(57) ABSTRACT

The present disclosure provides a method for fabricating an electrode, including the steps of: providing a plurality of carbon nanotubes; shaping the carbon nanotubes to form a plurality of carbon nanotube granules; and mixing the carbon nanotube granules with one or more polymers to form the electrode. The present disclosure also provides an electrode.

### BACKGROUND

1. Technical Field

The present disclosure relates to an electrode and a fabrication method thereof.

2. Description of the Related Art

Until now, various electrodes or electrode modules have been used in a wide range of devices such as fuel cells, batteries, and so on. Since the performance and manufacturing costs of these devices often depend greatly on the performance and the manufacturing costs of the electrodes or electrode modules therein, it is critical that the electrodes are manufactured at low costs and have superior material properties that lead to long term stability and optimized performances, where the material properties include, among others, high surface area, high electrical and thermal conductivity, high corrosion resistance, and high stability. Due to high conversion efficiency, environmental friendliness, and ability to start up at room temperature, polymer electrolyte fuel cells (PEFCs) have received great attention. Fuel cells are considered relatively clean energy sources that could potentially replace fossil fuel. A typical fuel cell comprises an anode, a cathode, a polymer exchange membrane (PEM) sandwiched between the anode and the cathode, and other optional components. The fuel cell is generally further provided with active materials that facilitate electrochemical reactions. However, PEMFCs have yet to be commercialized because both the manufacturing costs and the lifespan are still less than satisfactory, and the issue of having a short lifespan is generally caused by the harsh operation conditions (low pH, high humidity, and high operation potential) in PEMFCs that make electrodes therein prone to degradation and corrosion. Since active materials are often incorporate into the electrodes to facilitate the function of the electrodes, degradation and corrosion would thus have adverse effects on the electrode. Currently, various carbonaceous materials such as those comprising carbon black have been widely used as electrode materials. Porous carbonaceous materials have been developed to obtain increased surface area, and the main synthesis method for these materials is the template method, which involves using an organic or inorganic template. However, the template method is typically a multi-step process, and it is also time-consuming and not suitable for mass production. Particularly, the most concerning problem of porous carbonaceous material synthesized by this method is that electrode has low stability under harsh operation conditions (low pH, high humidity, and high operation potential).

Therefore, an improved electrode with long term stability, low manufacturing costs, and enhanced performance is needed.

### BRIEF SUMMARY

The disclosure provides a method for fabricating an electrode, comprising the steps of: providing a plurality of carbon nanotubes; shaping the carbon nanotubes to form a plurality of carbon nanotube granules; and mixing the carbon nanotube granules with one or more polymers to form the electrode.

The disclosure further provides an electrode, comprising: a plurality of conductive carbon nanotube granules.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 is a flowchart of a method 100 for fabricating an electrode comprising carbon nanotube granules according to embodiments of the present disclosure;

FIG. 2 is an illustrative diagram of carbon nanotube granules according to embodiments of the present disclosure;

FIG. 3 is a diagram of a gas adsorption/desorption curve for BET surface area analysis for the CNT and the CNT granules according to embodiments of the present disclosure;

FIG. 4 is an SEM image of the CNT according to Example 1 of the present disclosure;

FIG. 5 is an SEM image of the CNT granules according to Example 1 of the present disclosure;

FIGS. 6A-6B are SEM images of the CNT granules according to Example 2 of the present disclosure;

FIGS. 7A-7B are SEM images of the CNT granules according to Example 3 of the present disclosure; and

FIG. 8 is cyclic voltammetry curves according to Comparative Example 2 of the present disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

Carbon nanotubes have received a lot of attention due to their unique properties, and in particular, properties such as high corrosion resistance and high conductivity have made carbon nanotubes especially desirable for certain applications. However, there are still disadvantages in applying carbon nanotubes, for example, poor dispersion in solvents, which leads to insufficient surface area.

In this disclosure, a novel electrode comprising carbon nanotube granules and a fabrication method thereof are provided, wherein the carbon nanotube granules are fabricated by shaping the carbon nanotubes.

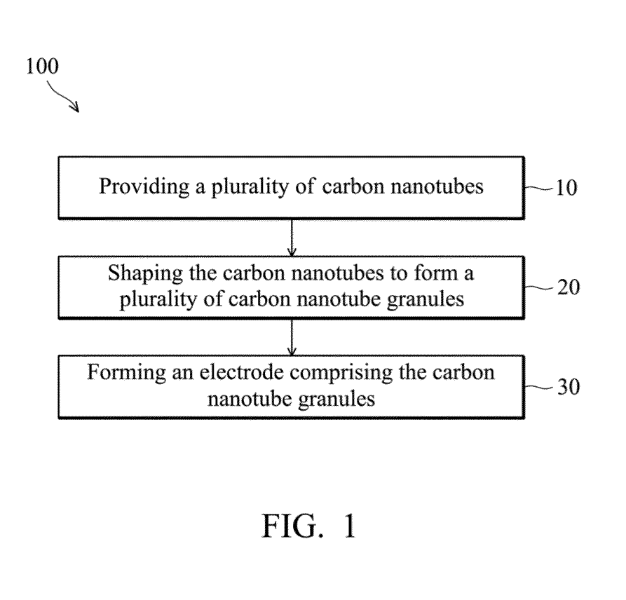

Illustrated in FIG. 1 is a flowchart of a method 100 for fabricating an electrode comprising carbon nanotube granules of the present disclosure. Referring to FIG. 1, the method 100 begins with step 10, in which a plurality of carbon nanotubes are provided. The carbon nanotubes may be either synthesized products or commercially available products. The carbon nanotubes may be single-walled carbon nanotubes and/or multi-walled carbon nanotubes. In one embodiment, the carbon nanotubes may have a diameter of about 2-100 nm and a length of about 5-30 μm. In an alternative embodiment, the carbon nanotubes may have a diameter of 20-40 nm and a length of 5-15 μm. In one embodiment, the aspect ratio (length/diameter) of the carbon nanotubes may be 50-5000.

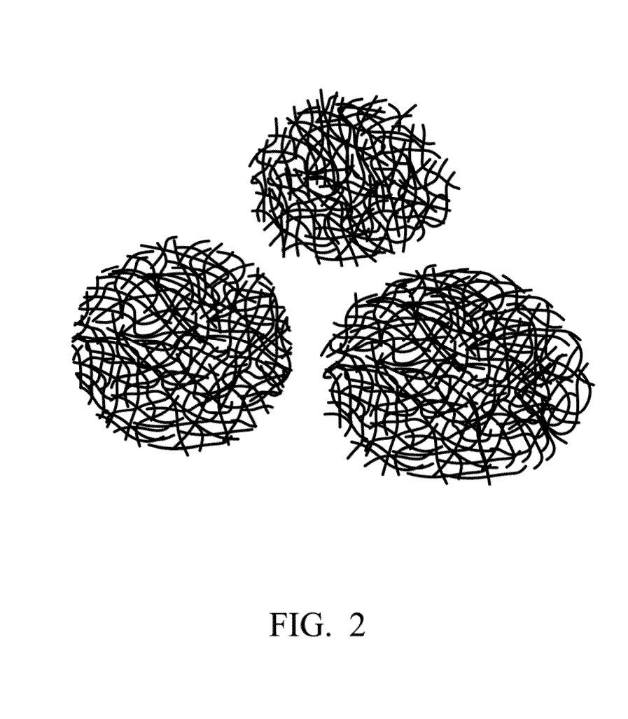

After performing step 10, the method 100 continues with step 20, in which the carbon nanotubes are shaped to form a plurality of carbon nanotube granules (shown in FIG. 2). Various phenomena may occur when shaping the carbon nanotubes, and these phenomena may comprise but are not limited to collisions between the carbon nanotubes, physical deformation of the carbon nanotubes such as bending, curling, winding, kinking, entanglement between the carbon nanotubes, or combinations thereof. In some embodiments, the carbon nanotubes may be shaped by applying a force such as a mechanical force to the carbon nanotubes. The mechanical force may comprise a shear force, a friction force, a contact force, a tension force, a normal force, an applied force, a spring force, or combinations thereof. The force may be applied by a device comprising a hybridizer, a tubular mixer, a high shear mixer, a cyclomix impact mixer, a dry impact blending coater, or combinations thereof. In some embodiments, the device may produce a tangential velocity of about 10-125 m/s, or about 25-100 m/s. Some of the devices described above have a rotor with a plurality of blades, and the rotor drives the rotation of the blades to provide the force. In some embodiments, the duration for applying the force may be 1-120 minutes, or 5-50 minutes. In some embodiments, the step 20 may involve continuous production. Continuous production is a method used to manufacture, produce, or process materials without interruption, and it is called a continuous process or a continuous flow process because the materials, either dry bulk or fluids that are being processed, are continuously in motion and undergoing chemical reactions or subjected to mechanical or heat treatment. However, in alternative embodiments, the step 20 may involve a batch process. In the embodiments where the step 20 involves a batch process, the amount of carbon nanotubes being processed per batch may be 1-1000 g/batch, or 2-7 g/batch. When the force is applied by the devices described above, the amount of force applied may be translated from for example the power of the rotor, the rotational speed of the rotor (or the tangential velocity of blades), etc. Thus, by adjusting the power of rotor, the rotational speed of the rotor (or the tangential velocity of blades), etc., the amount of force applied may be adjusted. Control over properties of the carbon nanotube granules such as porosity and granule size may be achieved by controlling the parameters of step 20, for example the duration for shaping the carbon nanotubes, the amount of force applied, the size of carbon nanotubes, and the amount of carbon nanotubes being processed. The carbon nanotube granules fabricated above are porous and may each comprise a plurality of carbon nanotubes electrically connected with each other to form a continuous conduction path. In some embodiments, the carbon nanotube granules are generally in a spherical shape. It is noted that in some embodiments, after the carbon nanotube granules have been formed, one or more active materials may be further incorporated into the carbon nanotube granules by a process such as one that employs the sol-gel technique. The term “active material” is used herein to refer to a material where the reaction actually takes place during a reaction. In some embodiments, the active material may comprise metal, metal oxide, or combinations thereof. Each of the metal and the metal oxide may comprise Pt, Ru, Au, Ag, Pd, Fe, Co, Ni, Cu, Li, Ti, Mg, Al, Zn, Mn, Ga, Ge, As, Mo, W, or combinations thereof. In some embodiments, the active material may be in the form of nanoparticles. For example, the sol-gel technique disclosed by Lin et al. (US 2007/0082137) may be used, and it is herein incorporated by reference in its entirety. A typical sol-gel technique for incorporating platinum nanoparticles into various structures involves mixing a carbonaceous material, a solvent, a reducing agent, a protecting agent, and a Pt precursor to form a solution and then heating the solution. The solvent may be for example methanol, ethanol, or combinations thereof. The Pt precursor may be for example H₂PtCl₆, K₂PtCl₆, PtCl₄, [Pt(NH)₃]₄Cl₂, or combinations thereof.

Next, the method 100 continues with step 30, in which an electrode comprising the carbon nanotube granules is formed. The electrode may be formed by mixing carbon nanotube granules with any suitable material for obtaining desirable electrode properties and performance. Suitable materials may comprise, but are not limited to, one or more polymers, one or more active materials described above, carbonaceous powder, solvent, or combinations thereof, wherein the carbonaceous powder may comprise graphite powder, carbon black, fullerene C60, active carbon or combinations thereof. It is noted that the incorporation of active material(s) described here with respect to step 30 is in addition to or alternative to the incorporation of active material(s) into the carbon nanotube granules described previously with respect to step 20. In a preferred embodiment, the carbon nanotube granules are mixed with one or more polymers and optionally an active material described above to form the electrode. The one or more polymers may comprise fluoropolymers, cellulose-copolymers, styrene-copolymers, or combinations thereof. Examples of fluoropolymers may include, but are not limited to, polyvinylidene fluoride and polytetrafluoroethylene. Examples of cellulose-copolymeres may include but are not limited to methyl cellulose, and carboxymethyl cellulose. Examples of styrene-copolymers may include, but are not limited to, styrene-butadiene rubber and nitrile butadiene rubber. In one embodiment, after mixing the carbon nanotube granules with one or more polymers and optionally an active material, the resultant mixture may be in the form of a paste. In this embodiment, the electrode may be formed, for example, by first applying the paste over the surface of a substrate and then carrying out one or more post treatments such as drying and sintering. A method such as spray coating, brush coating, blade coating, die coating, spin-coating, and immersion coating may be used to apply the paste. In some embodiments, the paste is homogenized and/or sonicated to achieve better homogeneity and mixing prior to being applied. In some embodiments, the sintering process may be carried out for a duration of between 20 minutes to 2 hours at 60° C.˜200° C. under a pressure of 1-10⁻² torr.

Additional processes may be performed during or after the method 100 so that the electrode may be incorporated into devices comprising fuel cells, supercapacitors, lithium-ion batteries, metal-air batteries, and so on, and these processes are disclosed by for example US 2009/0325024 A1, US 2009/0190286 A1, U.S. Pat. No. 7,858,236, and U.S. Pat. No. 5,665,481, all of which are herein incorporated by reference in their entirety.

Without intending to limit it in any manner, the present disclosure will be further illustrated by the following examples.

### EXAMPLE 1

A hybridizer having a rotor with blades was used, and carbon nanotubes (will be referred to as CNT herein) with a diameter of 20-40 nm and a length of 5-15 μm were fed into a hybridizer for being processed into carbon nanotube granules (will be referred to as CNT granules herein). The amount of CNT per batch was 3 g, the rotor speed was 16000 rpm, which may be roughly translated to a tangential speed of 100 m/s of the blades, and the processing time was 10 minutes.

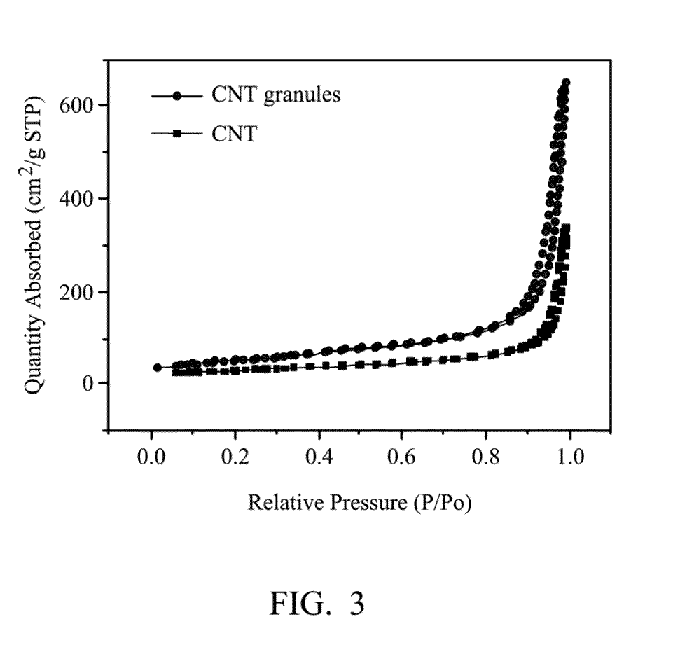

The BET surface area, micropore area, and mesopore area of the CNT and the CNT granules were measured, and the results are shown in Table 1. Further, FIG. 3 illustrates a diagram of a gas adsorption/desorption curve for BET surface area analysis for the CNT and the CNT granules. The results showed that after the CNT were processed into CNT granules, the BET surface area, micropore area, and mesopore area all increased.

TABLE 1

| | CNT | CNT Granules |
|---|---|---|
| BET surface area (m²/g) | 91.4 | 167.5 |
| Micropore area (m²/g) | 41.6 | 73.6 |
| Mesopore area (m²/g) | 70.4 | 141.5 |

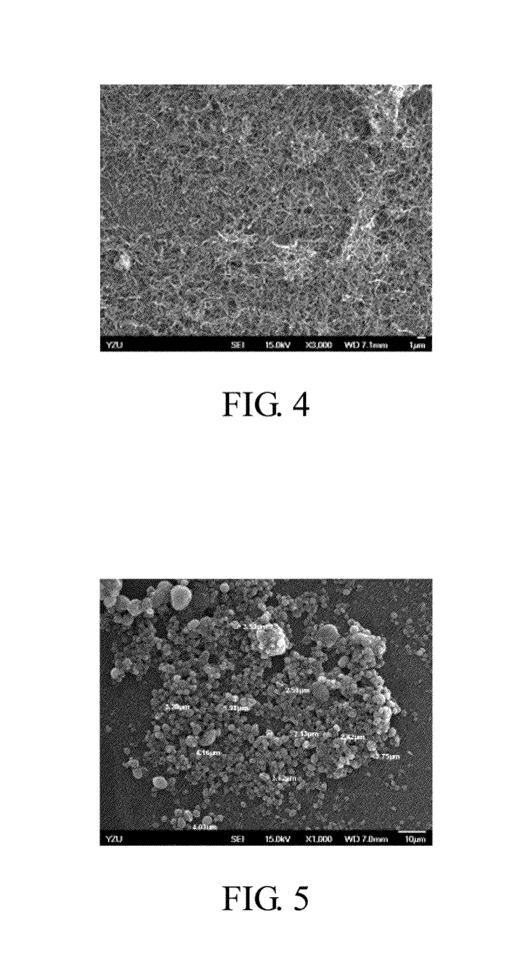

SEM images were taken for the CNT and the CNT granules, and it is shown that the CNT prior to processing (FIG. 4) were more disordered and distributed throughout space whereas the CNT granules after processing (FIG. 5) were more spherical granules.

### EXAMPLE 2

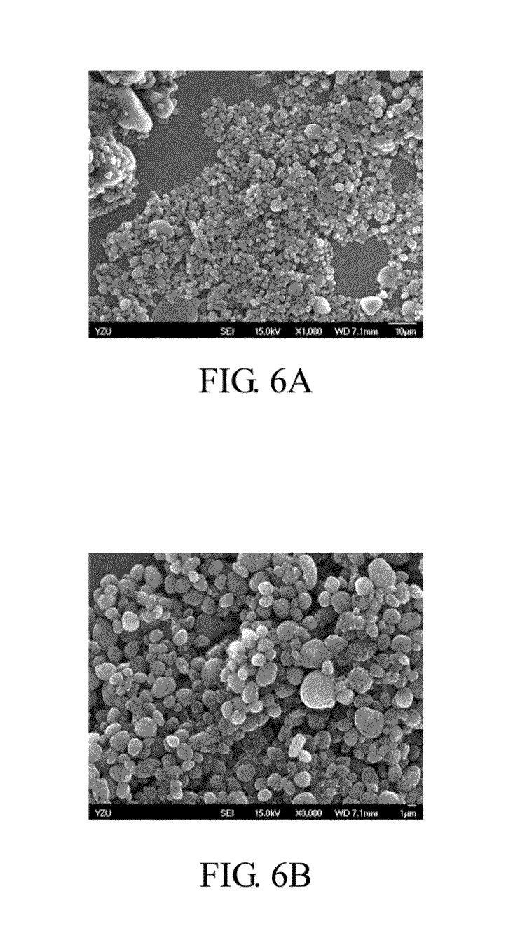

Processes similar to that of Example 1 were performed except that the amount of carbon nanotubes per batch was 7 g. SEM images were taken for the CNT granules and are shown in FIG. 6A-6B.

### EXAMPLE 3

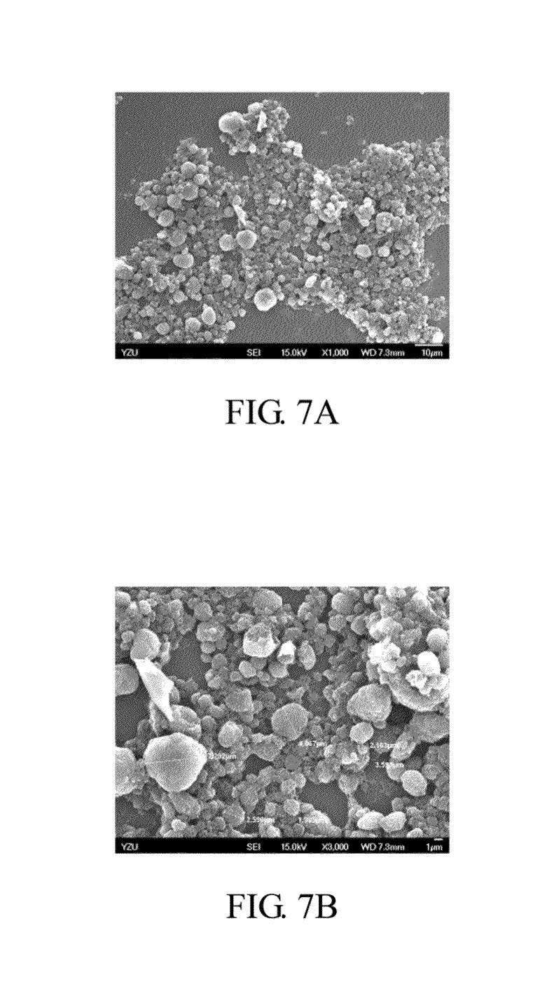

Processes similar to that of Example 1 were performed except that the processing time was 50 minutes. SEM images were taken for the CNT granules and are shown in FIG. 7A-7B.

### COMPARATIVE EXAMPLE 1

Precipitation tests were separately performed for the CNT and the CNT granules from Example 1 in deionized water. After 12 hours, it could be observed by the naked eyes that the CNT granules from Example 1 remained dispersed in deionized water whereas the CNT's from Example 1 precipitated and settled. This showed that the CNT granules fabricated by Example 1 had high dispersity in deionized water.

The results from the Examples and Comparative Example above showed that compared with the CNT prior to processing, the CNT granules obtained after the CNT were processed in the hybridizer had greater surface areas, good dispersion in deionized water, and higher porous property.

### EXAMPLE 4

The CNT granules of Example 1 were further processed to form Pt-doped CNT granules (Pt/CNT granules), and the process employed a sol-gel technique and comprised the following steps. The CNT granules were dispersed in a solution of dihydrogen hexachloroplatinate, sodium citrate, methanol, and deionized water with a volume mixing ratio of 3:2:50:45 to form an intermediate solution. In the intermediate solution, the concentration ratio of dihydrogen hexachloroplatinate to sodium citrate is 1.5:1. The intermediate solution was stirred for 10 minutes and then heated at 85° C. for 25 minutes.

### EXAMPLE 5

Processes similar to that of Example 4 were performed except that the CNT granules were replaced by the CNT of Example 1. Pt-doped CNT (Pt/CNT) were formed as a result.

### EXAMPLE 6

Processes similar to that of Example 4 were performed except that the CNT granules were replaced by carbon black (VULCAN® XC 72). Pt-doped carbon black (Pt/XC 72) was formed as a result.

### EXAMPLE 7

Processes similar to that of Example 4 were performed except that the CNT granules were replaced by acid-modified CNT, which were prepared by refluxing the CNT with 60% nitric acid at a temperature of about 140° C.˜160° C. for 1 hour. Pt-doped acid-modified CNT (Pt/acid-modified CNT) were formed as a result.

### COMPARATIVE EXAMPLE 2

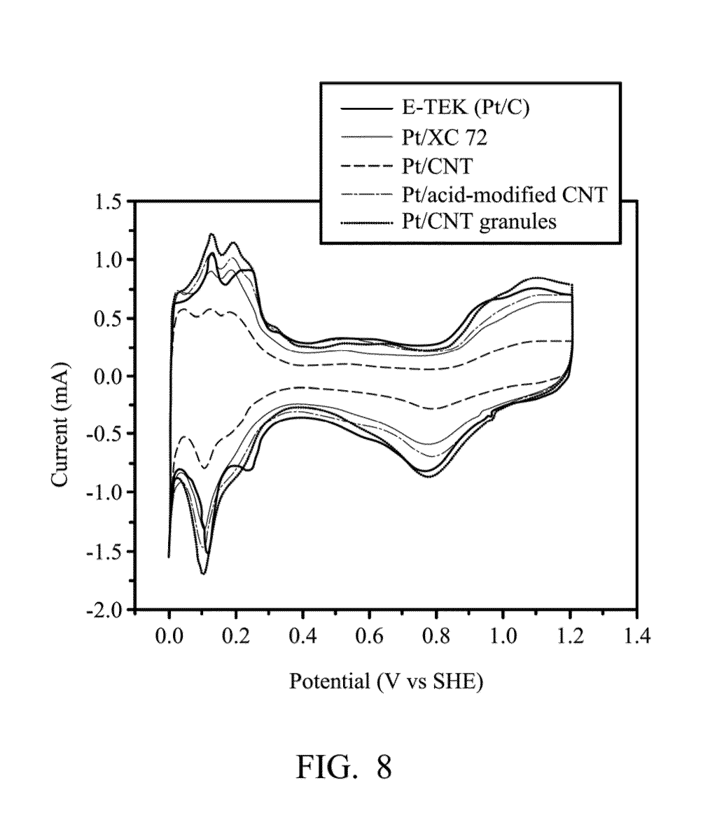

Cyclic voltammetry (CV) was carried out for platinum/carbon black (E-TEK) and the four Pt-doped species from Examples 4-7, which were Pt-doped CNT granules, Pt-doped CNT, Pt-doped carbon black, and Pt-doped acid-modified CNT, respectively. FIG. 8 shows the cyclic voltammetry curves obtained, and it was found that the Pt-doped CNT granules had a larger electrochemical window compared to the rest. Thus, the surfaces of the CNT granules were suitable for Pt doping, and the Pt-doped CNT granules had enhanced activity.

The Pt areas (H⁺ adsorption/desorption: m²/g_{Pt}) of platinum/carbon black (E-TEK) and the four Pt-doped species in deionized water were further calculated based on the cyclic voltammetry curves obtained using the formula below:

$$ECSA ( {cm}_{Pt}^{2} / {g}_{Pt} ) = \frac{{q}_{Pt}}{Γ \cdot L}$$

q_{Pt}: charge density obtained from the obtained CV (C/cm²electrode)

Γ: the charge to reduce a monolayer of protons on Pt and is 210 μC/cm²Pt

L: the Pt content or loading in the electrode, in g_{Pt}/cm² electrode

The details for the Pt area calculation can be found in Kinoshita et al. (K. Kinoshita and P. Stoneham “Preparation and Characterization of Highly Dispersed Electrocatalytic Materials” in Modern Aspects of Electrochemistry, Vol. 12, Chapter 4, J. O. M. Bockris and B. E. Conway, Eds., Plenum Press: New York, 183-266 (1977)), Ralph et al. (T. R. Ralph, G. A. Hards, J. E. Keating, S. A. Campbell, D. P. Wilkinson, M. Davis, J. St-Pierre and M. C. Johnson, “Low Cost Electrodes for Proton Exchange Membrane Fuel Cells—Performance in Single Cells and Ballard Stacks,” Journal of the Electrochemical Society, 144, 3845-3857 (1997)), or Gloaguen et al. (F. Gloaguen, J.-M. Leger and C. Lamy, “Electrocatalytic Oxidation of Methanol on Platinum Nanoparticles Electrodeposited onto Porous Carbon Substrates,” Journal of Applied Electrochemistry, 27, 1052 (1997)). The Pt area calculation results are shown in Table 2. It is noted that while FIG. 8 only shows one CV curve for each of the platinum/carbon black (E-TEK) and the four Pt-doped species from Examples 4-7, CV was actually carried out twice for the Pt/CNT granules (Example 4), Pt/XC 72 (Example 6), and Pt/acid-modified CNT (Example 7), respectively, and both of the CV curves obtained were used in calculating the Pt areas. Thus, for Pt/CNT granules (Example 4), Pt/XC 72 (Example 6), and Pt/acid-modified CNT (Example 7), two Pt area calculation results are shown.

TABLE 2

| | Pt area |
|---|---|
| Species | (H⁺ adsorption/desorption: m²/g Pt) |
| Pt/CNT granules (Example 4) | 118.2 |
| | 122.7 |
| Pt/CNT (Example 5) | 67.13 |
| Pt/XC 72 (Example 6) | 92.4 |
| | 91.3 |
| Pt/acid-modified CNT (Example 7) | 96.23 |
| | 93.6 |
| E-TEK (Pt/C) | 89.56 |

In summary, the present disclosure provides a simple fabrication method for processing carbon nanotube into carbon nanotube granules by applying a force, wherein the carbon nanotube granules obtained may be used in electrodes for various applications. Further, the carbon nanotube granules fabricated by the embodiments of the present disclosure not only had superior properties inherent in carbon nanotubes, for example high corrosion resistance and high conductivity, they also had increased surface area and good dispersion in solvents.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for fabricating an electrode, comprising the steps of:
providing a plurality of carbon nanotubes;
shaping the carbon nanotubes to form a plurality of carbon nanotube granules; and
mixing the carbon nanotube granules with one or more polymers to form the electrode.

2. The method for fabricating an electrode as claimed in claim 1, wherein shaping the carbon nanotubes comprises applying a force to the carbon nanotubes.

3. The method for fabricating an electrode as claimed in claim 2, wherein the force is a mechanical force, wherein the mechanical force comprises a shear force, a friction force, a contact force, a tension force, a normal force, an applied force, a spring force, or combinations thereof.

4. The method for fabricating an electrode as claimed in claim 2, wherein collisions between the carbon nanotubes occur when applying the force.

5. The method for fabricating an electrode as claimed in claim 2, wherein applying the force to the carbon nanotubes involves a batch process, and an amount of the carbon nanotubes used in each batch is about 1-1000 g, wherein each of the carbon nanotubes has a diameter of about 2-100 nm and a length of about 5-30 μm.

6. The method for fabricating an electrode as claimed in claim 1, further comprising a step of incorporating an active material into the carbon nanotube granules prior to the step of mixing the carbon nanotube granules with one or more polymers and/or a step of incorporating an active material into the electrode during the step of mixing the carbon nanotube granules with one or more polymers.

7. The method for fabricating an electrode as claimed in claim 6, wherein the active material comprises metal, metal oxide, or combinations thereof.

8. The method for fabricating an electrode as claimed in claim 7, wherein each of the metal and the metal oxide comprises Pt, Ru, Au, Ag, Pd, Fe, Co, Ni, Cu, Li, Ti, Mg, Al, Zn, Mn, Ga, Ge, As, Mo, W, or combinations thereof.

9. The method for fabricating an electrode as claimed in claim 1, wherein the one or more polymers comprise fluoropolymers, cellulose-copolymers, styrene-copolymers, or combinations thereof.

10. The method for fabricating an electrode as claimed in claim 1, wherein the one or more polymers comprise polyvinylidene fluoride, polytetrafluoroethylene, methyl cellulose, carboxymethyl cellulose, styrene-butadiene rubber, nitrile butadiene rubber, or combinations thereof.

11. An electrode, comprising:
a plurality of conductive carbon nanotube granules.

12. The electrode as claimed in claim 11, wherein the conductive carbon nanotube granules are fabricated by a method comprising the steps of:
providing a plurality of carbon nanotubes; and
shaping the carbon nanotubes to form the plurality of conductive carbon nanotube granules.

13. The electrode as claimed in claim 11, wherein the electrode further comprise an active material.

14. The electrode as claimed in claim 13, wherein the active material comprises metal, metal oxide, or combinations thereof.

15. The electrode as claimed in claim 14, wherein the each of the metal and the metal oxide comprises Pt, Ru, Au, Ag, Pd, Fe, Co, Ni, Cu, Li, Ti, Mg, Al, Zn, Mn, Ga, Ge, As, Mo, W, or combinations thereof.

16. The electrode as claimed in claim 11, wherein the electrode further comprises one or more polymers.

17. The electrode as claimed in claim 16, wherein the one or more polymers comprise fluoropolymers, cellulose-copolymers, styrene-copolymers, or combinations thereof.

18. The electrode as claimed in claim 16, wherein the one or more polymers comprise polyvinylidene fluoride, polytetrafluoroethylene, methyl cellulose, carboxymethyl cellulose, styrene-butadiene rubber, nitrile butadiene rubber, or combinations thereof.
